(19) United States
(12) Patent Application Publication
(10) Pub. No.: US 2025/0056395 A1
(43) Pub. Date: Feb. 13, 2025

(54) METHOD, APPARATUS AND COMPUTER PROGRAM

(71) Applicant: NOKIA TECHNOLOGIES OY, Espoo (FI)

(72) Inventors: Pallab GUPTA, Bangalore (IN); Saurabh KHARE, Bangalore (IN)

(21) Appl. No.: 18/798,990

(22) Filed: Aug. 9, 2024

(30) Foreign Application Priority Data
Aug. 12, 2023 (IN) 202341054275

(51) Int. Cl. H04W 48/18; H04W 60/00; H04W 84/04

(52) U.S. Cl. CPC H04W 48/18; H04W 60/005; H04W 84/042

(57) ABSTRACT

Various example embodiments of the subject disclosure relate to apparatus, methods and computer programs. For example, there is provided a user equipment comprising means for: registering the user equipment with a first public land mobile network; selecting a second public land mobile network to register a user equipment with based on the user equipment's registration with the first public land mobile network; and registering the user equipment with the selected second public land mobile network.

### CROSS-REFERENCE TO RELATED APPLICATIONS

This application claims priority to Indian Application No. 202341054275, filed Aug. 12, 2023, the entire contents of which are incorporated herein by reference.

### TECHNICAL FIELD

Various example embodiments of this subject disclosure relate to a methods, apparatus, systems and computer programs, and in particular (but not exclusively) to performing network selection.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communication sessions may comprise, for example, communication of data for carrying communications such as voice, video, electronic mail (email), text message, multimedia and/or content data and so on. Non-limiting and illustrative examples of services provided comprise two-way or multi-way calls, data communication or multimedia services and access to a data network system, such as the Internet.

In a wireless communication system at least a part of a communication session between at least two stations occurs over a wireless link. Examples of wireless systems comprise public land mobile networks (PLMN), satellite based communication systems and different wireless local networks, for example wireless local area networks (WLAN). Some wireless systems can be divided into cells, and are therefore often referred to as cellular systems.

A user can access the communication system by means of an appropriate communication device or terminal. A communication device of a user may be referred to as user equipment (UE) or user device. A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. One example of a communications system is UTRAN (3G radio). Other examples of communication systems are the long-term evolution (LTE) of the Universal Mobile Telecommunications System (UMTS) radio-access technology and so-called 5G or New Radio (NR) networks. NR is being standardized by the 3rd Generation Partnership Project (3GPP).

### SUMMARY

Various example embodiments of the subject disclosure aim at addressing at least part of the issue and/or problems and drawbacks either explicitly described herein or otherwise apparent to a person skilled in the relevant arts to provide methods, apparatus and computer programs by which mechanisms and/or procedures for network selection (but not exclusively) can be improved.

Several aspects of the various example embodiments will be described with respect to certain aspects. These aspects are not intended to indicate key or essential features of the various example embodiments, nor are they intended to be used to otherwise limit the scope of the subject disclosure. Other features, aspects and elements of the various example embodiments will be readily apparent to a person skilled in the art in view of the subject disclosure.

According to a first aspect, there is provided user equipment comprising means for: registering the user equipment with a first network; selecting a second network to register a user equipment with based on the user equipment's registration with the first network; and registering the user equipment with the selected second network.

The user equipment may further comprise means for: receiving information for selecting the second network, wherein: the information for selecting the second network may comprise information indicating one or more prioritized sets of candidate second networks, each prioritized set of candidate second networks may comprise a plurality of candidate second networks and may be associated with a respective combination of first network and access technology used by the user equipment to access the first network, and the selecting may be further based on the information for selecting the second network.

Selecting the second network may comprise: selecting one of the one or more prioritized sets of candidate second networks associated with the combination of first network and access technology used for the user equipment's registration with the first network; and selecting the second network from among the plurality of candidate second networks comprised in the selected prioritized set.

Selecting the second network from among the plurality of candidate second networks may be based on a priority order of the candidate second networks in the selected prioritized set.

Registering the user equipment with the first network may comprise sending, to the first network, information indicating that the user equipment supports dual registrations.

According to a second aspect there is provided an apparatus comprising means for: receiving information indicating that a user equipment supports dual registrations for registering with a first network and a second network; based on the receiving, determining to provide the user equipment with information for selecting the second network based on the user equipment's registration with the first network; and sending, to the user equipment, the information for selecting the second network.

The information for selecting the second network may comprise information indicating one or more prioritized sets of candidate second networks, wherein each prioritized set of candidate second networks may comprise a plurality of candidate second networks and may be associated with a respective combination of first network and access technology used by the user equipment to access the first network.

The information indicating that the user equipment supports dual registrations may be received during registering the user equipment with a home network or a visited network.

Determining to provide the user equipment with information for selecting the second network may comprise: determining to provide the user equipment with information for selecting the second network based on the information indicating that the user equipment supports dual registrations; or receiving, from a first application function, information for causing the apparatus to send, to the user equipment, the information for selecting the second network based on the user equipment's registration with the first network; and determining to provide the user equipment with the information for selecting the second network based on the information received from the first application function.

The first application function may be a steering of roaming application function.

The apparatus may further comprise means for: sending, to an authentication server function, a protection request comprising the information for selecting the second network; receiving, from the authentication server function, a protection response comprising a medium access control element; wherein sending the information for selecting the second network may further comprise sending the medium access control element.

The apparatus may be an apparatus for a unified data management function or an apparatus for a second application function.

According to a third aspect there is provided an apparatus for a first application function, the apparatus comprising means for: determining to cause sending, to a user equipment, information for selecting a second network based on the user equipment's registration with a first network; and sending, to an apparatus, information for causing the apparatus to send, to the user equipment, the information for selecting the second network based on the user equipment's registration with the first network.

The first application function may be a steering of roaming application function.

According to a fourth aspect there is provided an apparatus for an authentication server function, the apparatus comprising means for: receiving, from an apparatus, a protection request comprising information for a user equipment to perform selecting a second network based on the user equipment's registration with a first network; determining, based on the request, a medium access control element associated with the information for the user equipment to perform selecting the second network based on the user equipment's registration with the first network; and sending, to the apparatus, a protection response comprising the medium access control element.

According to a fifth aspect there is provided a home network of a user equipment comprising the apparatus of any of the second, third and fourth aspects.

According to a sixth aspect there is provided a user equipment comprising means for: registering the user equipment with a first public land mobile network; selecting a second public land mobile network to register a user equipment with based on the user equipment's registration with the first public land mobile network; and registering the user equipment with the selected second public land mobile network.

The user equipment may further comprise means for: receiving information for selecting the second public land mobile network, wherein: the information for selecting the second public land mobile network may comprise information indicating one or more prioritized sets of candidate second public land mobile networks, each prioritized set of candidate second public land mobile networks may comprise a plurality of candidate second public land mobile networks and is associated with a respective combination of first public land mobile network and access technology used by the user equipment to access the first public land mobile network, and the selecting may be further based on the information for selecting the second public land mobile network.

Selecting the second public land mobile network may comprise: selecting one of the one or more prioritized sets of candidate second public land mobile networks associated with the combination of first public land mobile network and access technology used for the user equipment's registration with the first public land mobile network; and selecting the second public land mobile network from among the plurality of candidate second public land mobile networks comprised in the selected prioritized set.

Selecting the second public land mobile network from among the plurality of candidate second public land mobile networks may be based on a priority order of the candidate second public land mobile networks in the selected prioritized set.

The information for selecting the second public land mobile network may comprise one or more of: an operator controlled second public land mobile network selector with access technology list; a user controlled second public land mobile network selector with access technology list; a second home public land mobile network selector with access technology list; an operator controlled public land mobile network selector with access technology list; a user controlled public land mobile network selector with access technology list; or a home public land mobile network selector with access technology list.

Registering the user equipment with the first public land mobile network may comprise sending, to the first public land mobile network, information indicating that the user equipment supports dual registrations.

According to a seventh aspect there is provided an apparatus comprising means for: receiving information indicating that a user equipment supports dual registrations for registering with a first public land mobile network and a second public land mobile network; based on the receiving, determining to provide the user equipment with information for selecting the second public land mobile network based on the user equipment's registration with the first public land mobile network; and sending, to the user equipment, the information for selecting the second public land mobile network.

The information for selecting the second public land mobile network may comprise information indicating one or more prioritized sets of candidate second public land mobile networks, wherein each prioritized set of candidate second public land mobile networks may comprise a plurality of candidate second public land mobile networks and may be associated with a respective combination of first public land mobile network and access technology used by the user equipment to access the first public land mobile network.

The information for selecting the second public land mobile network may comprise one or more of: an operator controlled second public land mobile network selector with access technology list; a second home public land mobile network selector with access technology list; a user controlled second public land mobile network selector with access technology list; an operator controlled public land mobile network selector with access technology list; a user controlled public land mobile network selector with access technology list; or a home public land mobile network selector with access technology list.

The information indicating that the user equipment supports dual registrations may be received during registering the user equipment with a home public land mobile network or visited public land mobile network.

Determining to provide the user equipment with information for selecting the second public land mobile network may comprise: determining to provide the user equipment with information for selecting the second public land mobile network based on the information indicating that the user equipment supports dual registrations; or receiving, from a first application function, information for causing the apparatus to send, to the user equipment, the information for selecting the second public land mobile network based on the user equipment's registration with the first public land mobile network; and determining to provide the user equipment with the information for selecting the second public land mobile network based on the information received from the first application function.

The first application function may be a steering of roaming application function.

The apparatus may further comprise means for: sending, to an authentication server function, a protection request comprising the information for selecting the second public land mobile network; receiving, from the authentication server function, a protection response comprising a medium access control element; wherein sending the information for selecting the second public land mobile network further may comprise sending the medium access control element.

The apparatus may be an apparatus for a unified data management function or an apparatus for a second application function.

According to an eighth aspect there is provided an apparatus for a first application function, the apparatus comprising means for: determining to cause sending, to a user equipment, information for selecting a second public land mobile network based on the user equipment's registration with a first public land mobile network; and sending, to an apparatus, information for causing the apparatus to send, to the user equipment, the information for selecting the second public land mobile network based on the user equipment's registration with the first public land mobile network.

The first application function may be a steering of roaming application function.

According to a ninth aspect, there is provided an apparatus for an authentication server function, the apparatus comprising means for: receiving, from an apparatus, a protection request comprising information for a user equipment to perform selecting a second public land mobile network based on the user equipment's registration with a first public land mobile network; determining, based on the request, a medium access control element associated with the information for the user equipment to perform selecting the second public land mobile network based on the user equipment's registration with the first public land mobile network; and sending, to the apparatus, a protection response comprising the medium access control element.

According to a tenth aspect, there is provided a home public land mobile network of a user equipment comprising: the apparatus of any of the seventh to ninth aspects.

According to an eleventh aspect, there is provided a user equipment comprising means for: registering the user equipment with a first network; selecting a standalone non-public network to register a user equipment with based on the user equipment's registration with the first network; and registering the user equipment with the selected standalone non-public network.

The user equipment may further comprise means for: receiving information for selecting the standalone non-public network, wherein: the information for selecting the standalone non-public network may comprise information indicating one or more prioritized sets of candidate standalone non-public networks, each prioritized set of candidate standalone non-public networks may comprise a plurality of candidate standalone non-public networks and may be associated with a respective combination of first network and access technology used by the user equipment to access the first network, and the selecting may be further based on the information for selecting the standalone non-public network.

Selecting the standalone non-public network may comprise: selecting one of the one or more prioritized sets of candidate standalone non-public networks associated with the combination of first network and access technology used for the user equipment's registration with the first network; and selecting the standalone non-public network from among the plurality of candidate standalone non-public networks comprised in the selected prioritized set.

Each prioritized set may comprise: an identifier of a subscribed standalone non-public network; and a prioritized list of candidate standalone non-public networks for second standalone non-public network selection.

The first network may be a public land mobile network, and wherein selecting the standalone non-public network from among the plurality of candidate standalone non-public networks comprised in the selected prioritized set may comprise: prioritizing the standalone non-public network corresponding to the identifier of the subscribed standalone non-public network; and when the standalone non-public network corresponding to the identifier of the subscribed standalone non-public network is unavailable, selecting the standalone non-public network based on the prioritized list of standalone non-public networks.

The first network may be a further standalone non-public network, and wherein selecting the standalone non-public network from among the plurality of candidate standalone non-public networks comprised in the selected prioritized set may comprise: selecting the standalone non-public network based on the prioritized list of standalone non-public networks.

The user equipment may have a registration associated with a public land mobile network subscription, and wherein the information for selecting the standalone non-public network may comprise one or more of: a user controlled prioritized list of preferred standalone non-public networks; a credentials holder controlled prioritized list of preferred standalone non-public networks; and a credentials holder controlled prioritized list of group identifiers for network selection.

Registering the user equipment with the first network may comprise sending, to the first network, information indicating that the user equipment supports dual registrations.

According to a twelfth aspect there is provided an apparatus comprising means for: receiving information indicating that a user equipment supports dual registrations for registering with a first network and a standalone non-public network; based on the receiving, determining to provide the user equipment with information for selecting the standalone non-public network based on the user equipment's registration with the first network; and sending, to the user equipment, the information for selecting the standalone non-public network.

The information for selecting the standalone non-public network may comprise information indicating one or more prioritized sets of candidate standalone non-public networks, and wherein each prioritized set of candidate standalone non-public networks may comprise a plurality of candidate standalone non-public networks and may be associated with a respective combination of first network and access technology used by the user equipment to access the first network.

Each prioritized set may comprise: an identifier of a subscribed standalone non-public network; and a prioritized list of candidate standalone non-public networks for second standalone non-public network selection.

The user equipment may have a registration associated with a public land mobile network subscription, and wherein the information for selecting the standalone non-public network may comprise one or more of: a user controlled prioritized list of preferred standalone non-public networks; a credentials holder controlled prioritized list of preferred standalone non-public networks; and a credentials holder controlled prioritized list of group identifiers for network selection.

The information indicating that the user equipment supports dual registrations may be received during registering the user equipment with a standalone non-public network.

Determining to provide the user equipment with information for selecting the standalone non-public network may comprise: determining to provide the user equipment with information for selecting the standalone non-public network based on the information indicating that the user equipment supports dual registrations; or receiving, from a first application function, information for causing the apparatus to send, to the user equipment, the information for selecting the second network based on the user equipment's registration with the first network; and determining to provide the user equipment with the information for selecting the second network based on the information received from the first application function.

The first application function may be a steering of roaming application function.

The apparatus may further comprise means for: sending, to an authentication server function, a protection request comprising the information for selecting the standalone non-public network; receiving, from the authentication server function, a protection response comprising a medium access control element; wherein sending the information for selecting the standalone non-public network may further comprise sending the medium access control element.

The apparatus may be an apparatus for a subscribed standalone non-public network or an apparatus for a credential holder network.

The credential holder network may be a further standalone non-public network or a home public land mobile network.

According to a thirteenth aspect there is provided an apparatus for a first application function, the apparatus comprising means for: determining to cause sending, to a user equipment, information for selecting a standalone non-public network based on the user equipment's registration with a first network; and sending, to an apparatus, information for causing the apparatus to send, to the user equipment, the information for selecting the standalone non-public network based on the user equipment's registration with the first network.

The first application function may be a steering of roaming application function.

According to a fourteenth aspect there is provided an apparatus for an authentication server function, the apparatus comprising means for: receiving, from an apparatus, a protection request comprising information for a user equipment to perform selecting a standalone non-public network based on the user equipment's registration with a first network; determining, based on the request, a medium access control element associated with the information for the user equipment to perform selecting the standalone non-public network based on the user equipment's registration with the first network; and sending, to the apparatus, a protection response comprising the medium access control element.

According to a fifteenth aspect there is provided a subscribed standalone non-public network or credential holder network of the user equipment comprising the apparatus of any of the twelfth to fourteenth aspects.

According to a sixteenth aspect, there is provided a user equipment comprising at least one processor and at least one memory storing instructions that, when executed by the at least one processor, cause the user equipment at least to: register the user equipment with a first network; select a second network to register a user equipment with based on the user equipment's registration with the first network; and register the user equipment with the selected second network.

The at least one processor may be configured to cause the user equipment to: receive information for selecting the second network, wherein: the information for selecting the second network may comprise information indicating one or more prioritized sets of candidate second networks, each prioritized set of candidate second networks may comprise a plurality of candidate second networks and may be associated with a respective combination of first network and access technology used by the user equipment to access the first network, and the at least one processor may be configured to cause the user equipment to select the second network further based on the information for selecting the second network.

The at least one processor may be configured to cause the user equipment to: select one of the one or more prioritized sets of candidate second networks associated with the combination of first network and access technology used for the user equipment's registration with the first network; and select the second network from among the plurality of candidate second networks comprised in the selected prioritized set.

The at least one processor may be configured to cause the user equipment to select the second network from among the plurality of candidate second networks based on a priority order of the candidate second networks in the selected prioritized set.

The at least one processor may be configured to cause the user equipment to send, to the first network, information indicating that the user equipment supports dual registrations.

According to a seventeenth aspect, there is provided an apparatus comprising at least one processor and at least one memory storing instructions that, when executed by the at least one processor, cause the apparatus at least to: receive information indicating that a user equipment supports dual registrations for registering with a first network and a second network; based on the receiving, determine to provide the user equipment with information for selecting the second network based on the user equipment's registration with the first network; and send, to the user equipment, the information for selecting the second network.

The information for selecting the second network may comprise information indicating one or more prioritized sets of candidate second networks, wherein each prioritized set of candidate second networks may comprise a plurality of candidate second networks and may be associated with a respective combination of first network and access technology used by the user equipment to access the first network.

The information indicating that the user equipment supports dual registrations may be received during registering the user equipment with a home network or a visited network.

The at least one processor may be configured to cause the apparatus to: determine to provide the user equipment with information for selecting the second network based on the information indicating that the user equipment supports dual registrations; or receive, from a first application function, information for causing the apparatus to send, to the user equipment, the information for selecting the second network based on the user equipment's registration with the first network; and determine to provide the user equipment with the information for selecting the second network based on the information received from the first application function.

The first application function may be a steering of roaming application function.

The at least one processor may be configured to cause the apparatus to: send, to an authentication server function, a protection request comprising the information for selecting the second network; receive, from the authentication server function, a protection response comprising a medium access control element; wherein at least one processor may be configured to cause the apparatus to send the medium access control element to the user equipment.

The apparatus may be an apparatus for a unified data management function or an apparatus for a second application function.

According to an eighteenth aspect, there is provided an apparatus for a first application function, the apparatus comprising at least one processor and at least one memory storing instructions that, when executed by the at least one processor, cause the apparatus at least to: determine to cause sending, to a user equipment, information for selecting a second network based on the user equipment's registration with a first network; and send, to an apparatus, information for causing the apparatus to send, to the user equipment, the information for selecting the second network based on the user equipment's registration with the first network.

The first application function may be a steering of roaming application function.

According to a nineteenth aspect, there is provided an apparatus for an authentication server function, the apparatus comprising at least one processor and at least one memory storing instructions that, when executed by the at least one processor, cause the apparatus at least to: receive, from an apparatus, a protection request comprising information for a user equipment to perform selecting a second network based on the user equipment's registration with a first network; determine, based on the request, a medium access control element associated with the information for the user equipment to perform selecting the second network based on the user equipment's registration with the first network; and send, to the apparatus, a protection response comprising the medium access control element.

According to a twentieth aspect there is provided a home network of a user equipment comprising the apparatus of any of the seventeenth to nineteenth aspects.

According to a twenty-first aspect, there is provided a user equipment comprising at least one processor and at least one memory storing instructions that, when executed by the at least one processor, cause the user equipment at least to: register the user equipment with a first public land mobile network; select a second public land mobile network to register a user equipment with based on the user equipment's registration with the first public land mobile network; and register the user equipment with the selected second public land mobile network.

The at least one processor may be configured to cause the user equipment to: receive information for selecting the second public land mobile network, wherein: the information for selecting the second public land mobile network may comprise information indicating one or more prioritized sets of candidate second public land mobile networks, each prioritized set of candidate second public land mobile networks may comprise a plurality of candidate second public land mobile networks and is associated with a respective combination of first public land mobile network and access technology used by the user equipment to access the first public land mobile network, and the selecting may be further based on the information for selecting the second public land mobile network.

The at least one processor may be configured to cause the user equipment to: select one of the one or more prioritized sets of candidate second public land mobile networks associated with the combination of first public land mobile network and access technology used for the user equipment's registration with the first public land mobile network; and select the second public land mobile network from among the plurality of candidate second public land mobile networks comprised in the selected prioritized set.

The at least one processor may be configured to cause the user equipment to select the second public land mobile network from among the plurality of candidate second public land mobile networks based on a priority order of the candidate second public land mobile networks in the selected prioritized set.

The information for selecting the second public land mobile network may comprise one or more of: an operator controlled second public land mobile network selector with access technology list; a user controlled second public land mobile network selector with access technology list; a second home public land mobile network selector with access technology list; an operator controlled public land mobile network selector with access technology list; a user controlled public land mobile network selector with access technology list; or a home public land mobile network selector with access technology list.

The at least one processor may be configured to cause the user equipment to send, to the first public land mobile network, information indicating that the user equipment supports dual registrations.

According to a twenty-second aspect, there is provided an apparatus comprising at least one processor and at least one memory storing instructions that, when executed by the at least one processor, cause the apparatus at least to: receive information indicating that a user equipment supports dual registrations for registering with a first public land mobile network and a second public land mobile network; based on the receiving, determine to provide the user equipment with information for selecting the second public land mobile network based on the user equipment's registration with the first public land mobile network; and send, to the user equipment, the information for selecting the second public land mobile network.

The information for selecting the second public land mobile network may comprise information indicating one or more prioritized sets of candidate second public land mobile networks, wherein each prioritized set of candidate second public land mobile networks may comprise a plurality of candidate second public land mobile networks and may be associated with a respective combination of first public land mobile network and access technology used by the user equipment to access the first public land mobile network.

The information for selecting the second public land mobile network may comprise one or more of: an operator controlled second public land mobile network selector with access technology list; a second home public land mobile network selector with access technology list; a user controlled second public land mobile network selector with access technology list; an operator controlled public land mobile network selector with access technology list; a user controlled public land mobile network selector with access technology list; or a home public land mobile network selector with access technology list.

The information indicating that the user equipment supports dual registrations may be received during registering the user equipment with a home public land mobile network or visited public land mobile network.

The at least one processor may be configured to cause the apparatus to: determine to provide the user equipment with information for selecting the second public land mobile network based on the information indicating that the user equipment supports dual registrations; or receive, from a first application function, information for causing the apparatus to send, to the user equipment, the information for selecting the second public land mobile network based on the user equipment's registration with the first public land mobile network; and determine to provide the user equipment with the information for selecting the second public land mobile network based on the information received from the first application function.

The first application function may be a steering of roaming application function.

The at least one processor may be configured to cause the apparatus to: send, to an authentication server function, a protection request comprising the information for selecting the second public land mobile network; receive, from the authentication server function, a protection response comprising a medium access control element; wherein the at least one processor may be configured to cause the apparatus to send the medium access control element to the user equipment.

The apparatus may be an apparatus for a unified data management function or an apparatus for a second application function.

According to a twenty-third aspect, there is provided an apparatus for a first application function, the apparatus comprising at least one processor and at least one memory storing instructions that, when executed by the at least one processor, cause the apparatus at least to: determine to cause sending, to a user equipment, information for selecting a second public land mobile network based on the user equipment's registration with a first public land mobile network; and send, to an apparatus, information for causing the apparatus to send, to the user equipment, the information for selecting the second public land mobile network based on the user equipment's registration with the first public land mobile network.

The first application function may be a steering of roaming application function.

According to a twenty-fourth aspect, there is provided an apparatus for an authentication server function, the apparatus comprising at least one processor and at least one memory storing instructions that, when executed by the at least one processor, cause the apparatus at least to: receive, from an apparatus, a protection request comprising information for a user equipment to perform selecting a second public land mobile network based on the user equipment's registration with a first public land mobile network; determine, based on the request, a medium access control element associated with the information for the user equipment to perform selecting the second public land mobile network based on the user equipment's registration with the first public land mobile network; and send, to the apparatus, a protection response comprising the medium access control element.

According to a twenty-fifth aspect, there is provided a home public land mobile network of a user equipment comprising: the apparatus of any of the twenty-second to twenty-fourth aspects.

According to a twenty-sixth aspect, there is provided a user equipment comprising at least one processor and at least one memory storing instructions that, when executed by the at least one processor, cause the user equipment at least to: register the user equipment with a first network; select a standalone non-public network to register a user equipment with based on the user equipment's registration with the first network; and register the user equipment with the selected standalone non-public network.

The at least one processor may be configured to cause the user equipment to: receive information for selecting the standalone non-public network, wherein: the information for selecting the standalone non-public network may comprise information indicating one or more prioritized sets of candidate standalone non-public networks, each prioritized set of candidate standalone non-public networks may comprise a plurality of candidate standalone non-public networks and may be associated with a respective combination of first network and access technology used by the user equipment to access the first network, and the selecting may be further based on the information for selecting the standalone non-public network.

The at least one processor may be configured to cause the user equipment to: select one of the one or more prioritized sets of candidate standalone non-public networks associated with the combination of first network and access technology used for the user equipment's registration with the first network; and select the standalone non-public network from among the plurality of candidate standalone non-public networks comprised in the selected prioritized set.

Each prioritized set may comprise: an identifier of a subscribed standalone non-public network; and a prioritized list of candidate standalone non-public networks for second standalone non-public network selection.

The first network may be a public land mobile network, and wherein the at least one processor may be configured to cause the user equipment to: prioritize the standalone non-public network corresponding to the identifier of the subscribed standalone non-public network; and when the standalone non-public network corresponding to the identifier of the subscribed standalone non-public network is unavailable, select the standalone non-public network based on the prioritized list of standalone non-public networks.

The first network may be a further standalone non-public network, and wherein the at least one processor may be configured to cause the user equipment to: select the standalone non-public network based on the prioritized list of standalone non-public networks.

The user equipment may have a registration associated with a public land mobile network subscription, and wherein the information for selecting the standalone non-public network may comprise one or more of: a user controlled prioritized list of preferred standalone non-public networks; a credentials holder controlled prioritized list of preferred standalone non-public networks; and a credentials holder controlled prioritized list of group identifiers for network selection.

The at least one processor may be configured to cause the apparatus to send, to the first network, information indicating that the user equipment supports dual registrations.

According to a twenty-seventh aspect, there is provided an apparatus comprising at least one processor and at least one memory storing instructions that, when executed by the at least one processor, cause the apparatus at least to: receive information indicating that a user equipment supports dual registrations for registering with a first network and a standalone non-public network; based on the receiving, determine to provide the user equipment with information for selecting the standalone non-public network based on the user equipment's registration with the first network; and send, to the user equipment, the information for selecting the standalone non-public network.

The information for selecting the standalone non-public network may comprise information indicating one or more prioritized sets of candidate standalone non-public networks, and wherein each prioritized set of candidate standalone non-public networks may comprise a plurality of candidate standalone non-public networks and may be associated with a respective combination of first network and access technology used by the user equipment to access the first network.

Each prioritized set may comprise: an identifier of a subscribed standalone non-public network; and a prioritized list of candidate standalone non-public networks for second standalone non-public network selection.

The user equipment may have a registration associated with a public land mobile network subscription, and wherein the information for selecting the standalone non-public network may comprise one or more of: a user controlled prioritized list of preferred standalone non-public networks; a credentials holder controlled prioritized list of preferred standalone non-public networks; and a credentials holder controlled prioritized list of group identifiers for network selection.

The information indicating that the user equipment supports dual registrations may be received during registering the user equipment with a standalone non-public network.

The at least one processor may be configured to cause the apparatus to: determine to provide the user equipment with information for selecting the standalone non-public network based on the information indicating that the user equipment supports dual registrations; or receive, from a first application function, information for causing the apparatus to send, to the user equipment, the information for selecting the second network based on the user equipment's registration with the first network; and determine to provide the user equipment with the information for selecting the second network based on the information received from the first application function.

The first application function may be a steering of roaming application function.

The at least one processor may be configured to cause the apparatus to: send, to an authentication server function, a protection request comprising the information for selecting the standalone non-public network; receive, from the authentication server function, a protection response comprising a medium access control element; where the at least one processor may be configured to cause the apparatus to send the medium access control element to the user equipment.

The apparatus may be an apparatus for a subscribed standalone non-public network or an apparatus for a credential holder network.

The credential holder network may be a further standalone non-public network or a home public land mobile network.

According to a twenty-eighth aspect, there is provided an apparatus for a first application function, the apparatus comprising at least one processor and at least one memory storing instructions that, when executed by the at least one processor, cause the apparatus at least to: determine to cause sending, to a user equipment, information for selecting a standalone non-public network based on the user equipment's registration with a first network; and send, to an apparatus, information for causing the apparatus to send, to the user equipment, the information for selecting the standalone non-public network based on the user equipment's registration with the first network.

The first application function may be a steering of roaming application function.

According to twenty-ninth aspect, there is provided an apparatus for an authentication server function, the apparatus comprising at least one processor and at least one memory storing instructions that, when executed by the at least one processor, cause the apparatus at least to: receive, from an apparatus, a protection request comprising information for a user equipment to perform selecting a standalone non-public network based on the user equipment's registration with a first network; determine, based on the request, a medium access control element associated with the information for the user equipment to perform selecting the standalone non-public network based on the user equipment's registration with the first network; and send, to the apparatus, a protection response comprising the medium access control element.

According to a thirtieth aspect there is provided a subscribed standalone non-public network or credential holder network of the user equipment comprising the apparatus of any of the twenty-seventh to twenty-ninth aspects.

According to a thirty-first aspect, there is provided a method performed by a user equipment, the method comprising: registering the user equipment with a first network; selecting a second network to register a user equipment with based on the user equipment's registration with the first network; and registering the user equipment with the selected second network.

The method may further comprise: receiving information for selecting the second network, wherein: the information for selecting the second network may comprise information indicating one or more prioritized sets of candidate second networks, each prioritized set of candidate second networks may comprise a plurality of candidate second networks and may be associated with a respective combination of first network and access technology used by the user equipment to access the first network, and the selecting may be further based on the information for selecting the second network.

Selecting the second network may comprise: selecting one of the one or more prioritized sets of candidate second networks associated with the combination of first network and access technology used for the user equipment's registration with the first network; and selecting the second network from among the plurality of candidate second networks comprised in the selected prioritized set.

Selecting the second network from among the plurality of candidate second networks may be based on a priority order of the candidate second networks in the selected prioritized set.

Registering the user equipment with the first network may comprise sending, to the first network, information indicating that the user equipment supports dual registrations.

According to a thirty-second aspect there is provided a method comprising: receiving information indicating that a user equipment supports dual registrations for registering with a first network and a second network; based on the receiving, determining to provide the user equipment with information for selecting the second network based on the user equipment's registration with the first network; and sending, to the user equipment, the information for selecting the second network.

The information for selecting the second network may comprise information indicating one or more prioritized sets of candidate second networks, wherein each prioritized set of candidate second networks may comprise a plurality of candidate second networks and may be associated with a respective combination of first network and access technology used by the user equipment to access the first network.

The information indicating that the user equipment supports dual registrations may be received during registering the user equipment with a home network or a visited network.

Determining to provide the user equipment with information for selecting the second network may comprise: determining to provide the user equipment with information for selecting the second network based on the information indicating that the user equipment supports dual registrations; or receiving, from a first application function, information for causing the apparatus to send, to the user equipment, the information for selecting the second network based on the user equipment's registration with the first network; and determining to provide the user equipment with the information for selecting the second network based on the information received from the first application function.

The first application function may be a steering of roaming application function.

The method may further comprise: sending, to an authentication server function, a protection request comprising the information for selecting the second network; receiving, from the authentication server function, a protection response comprising a medium access control element; wherein sending the information for selecting the second network may further comprise sending the medium access control element.

The method may be performed by a unified data management function or a second application function.

According to a thirty-third aspect there is provided a method performed by a first application function, the method comprising: determining to cause sending, to a user equipment, information for selecting a second network based on the user equipment's registration with a first network; and sending, to an apparatus, information for causing the apparatus to send, to the user equipment, the information for selecting the second network based on the user equipment's registration with the first network.

The first application function may be a steering of roaming application function.

According to a thirty-fourth aspect there is provided a method performed by an authentication server function, the method comprising: receiving, from an apparatus, a protection request comprising information for a user equipment to perform selecting a second network based on the user equipment's registration with a first network; determining, based on the request, a medium access control element associated with the information for the user equipment to perform selecting the second network based on the user equipment's registration with the first network; and sending, to the apparatus, a protection response comprising the medium access control element.

According to a thirty-fifth aspect there is provided a method performed by a home network of a user equipment, the method comprising the methods of any of the thirty-second to thirty-fourth aspects.

According to a thirty-sixth aspect there is provided a method performed by a user equipment, the method comprising: registering the user equipment with a first public land mobile network; selecting a second public land mobile network to register a user equipment with based on the user equipment's registration with the first public land mobile network; and registering the user equipment with the selected second public land mobile network.

The method may further comprise: receiving information for selecting the second public land mobile network, wherein: the information for selecting the second public land mobile network may comprise information indicating one or more prioritized sets of candidate second public land mobile networks, each prioritized set of candidate second public land mobile networks may comprise a plurality of candidate second public land mobile networks and is associated with a respective combination of first public land mobile network and access technology used by the user equipment to access the first public land mobile network, and the selecting may be further based on the information for selecting the second public land mobile network.

Selecting the second public land mobile network may comprise: selecting one of the one or more prioritized sets of candidate second public land mobile networks associated with the combination of first public land mobile network and access technology used for the user equipment's registration with the first public land mobile network; and selecting the second public land mobile network from among the plurality of candidate second public land mobile networks comprised in the selected prioritized set.

Selecting the second public land mobile network from among the plurality of candidate second public land mobile networks may be based on a priority order of the candidate second public land mobile networks in the selected prioritized set.

The information for selecting the second public land mobile network may comprise one or more of: an operator controlled second public land mobile network selector with access technology list; a user controlled second public land mobile network selector with access technology list; a second home public land mobile network selector with access technology list; an operator controlled public land mobile network selector with access technology list; a user controlled public land mobile network selector with access technology list; or a home public land mobile network selector with access technology list.

Registering the user equipment with the first public land mobile network may comprise sending, to the first public land mobile network, information indicating that the user equipment supports dual registrations.

According to a thirty-seventh aspect there is provided a method comprising: receiving information indicating that a user equipment supports dual registrations for registering with a first public land mobile network and a second public land mobile network; based on the receiving, determining to provide the user equipment with information for selecting the second public land mobile network based on the user equipment's registration with the first public land mobile network; and sending, to the user equipment, the information for selecting the second public land mobile network.

The information for selecting the second public land mobile network may comprise information indicating one or more prioritized sets of candidate second public land mobile networks, wherein each prioritized set of candidate second public land mobile networks may comprise a plurality of candidate second public land mobile networks and may be associated with a respective combination of first public land mobile network and access technology used by the user equipment to access the first public land mobile network.

The information for selecting the second public land mobile network may comprise one or more of: an operator controlled second public land mobile network selector with access technology list; a second home public land mobile network selector with access technology list; a user controlled second public land mobile network selector with access technology list; an operator controlled public land mobile network selector with access technology list; a user controlled public land mobile network selector with access technology list; or a home public land mobile network selector with access technology list.

The information indicating that the user equipment supports dual registrations may be received during registering the user equipment with a home public land mobile network or visited public land mobile network.

Determining to provide the user equipment with information for selecting the second public land mobile network may comprise: determining to provide the user equipment with information for selecting the second public land mobile network based on the information indicating that the user equipment supports dual registrations; or receiving, from a first application function, information for causing the apparatus to send, to the user equipment, the information for selecting the second public land mobile network based on the user equipment's registration with the first public land mobile network; and determining to provide the user equipment with the information for selecting the second public land mobile network based on the information received from the first application function.

The first application function may be a steering of roaming application function.

The method may further comprise: sending, to an authentication server function, a protection request comprising the information for selecting the second public land mobile network; receiving, from the authentication server function, a protection response comprising a medium access control element; wherein sending the information for selecting the second public land mobile network further may comprise sending the medium access control element.

The method may be performed by a unified data management function or a second application function.

According to an thirty-eighth aspect there is provided a method performed by a first application function, the method comprising: determining to cause sending, to a user equipment, information for selecting a second public land mobile network based on the user equipment's registration with a first public land mobile network; and sending, to an apparatus, information for causing the apparatus to send, to the user equipment, the information for selecting the second public land mobile network based on the user equipment's registration with the first public land mobile network.

The first application function may be a steering of roaming application function.

According to a thirty-ninth aspect, there is provided a method performed by an authentication server function, the method comprising: receiving, from an apparatus, a protection request comprising information for a user equipment to perform selecting a second public land mobile network based on the user equipment's registration with a first public land mobile network; determining, based on the request, a medium access control element associated with the information for the user equipment to perform selecting the second public land mobile network based on the user equipment's registration with the first public land mobile network; and sending, to the apparatus, a protection response comprising the medium access control element.

According to a fortieth aspect, there is provided a method performed by a home public land mobile network of a user equipment, the method comprising the method of any of the thirty-seventy to thirty-ninth aspects.

According to an forty-first aspect, there is provided a method performed by a user equipment, the method comprising: registering the user equipment with a first network; selecting a standalone non-public network to register a user equipment with based on the user equipment's registration with the first network; and registering the user equipment with the selected standalone non-public network.

The method may further comprise: receiving information for selecting the standalone non-public network, wherein: the information for selecting the standalone non-public network may comprise information indicating one or more prioritized sets of candidate standalone non-public networks, each prioritized set of candidate standalone non-public networks may comprise a plurality of candidate standalone non-public networks and may be associated with a respective combination of first network and access technology used by the user equipment to access the first network, and the selecting may be further based on the information for selecting the standalone non-public network.

Selecting the standalone non-public network may comprise: selecting one of the one or more prioritized sets of candidate standalone non-public networks associated with the combination of first network and access technology used for the user equipment's registration with the first network; and selecting the standalone non-public network from among the plurality of candidate standalone non-public networks comprised in the selected prioritized set.

Each prioritized set may comprise: an identifier of a subscribed standalone non-public network; and a prioritized list of candidate standalone non-public networks for second standalone non-public network selection.

The first network may be a public land mobile network, and wherein selecting the standalone non-public network from among the plurality of candidate standalone non-public networks comprised in the selected prioritized set may comprise: prioritizing the standalone non-public network corresponding to the identifier of the subscribed standalone non-public network; and when the standalone non-public network corresponding to the identifier of the subscribed standalone non-public network is unavailable, selecting the standalone non-public network based on the prioritized list of standalone non-public networks.

The first network may be a further standalone non-public network, and wherein selecting the standalone non-public network from among the plurality of candidate standalone non-public networks comprised in the selected prioritized set may comprise: selecting the standalone non-public network based on the prioritized list of standalone non-public networks.

The user equipment may have a registration associated with a public land mobile network subscription, and wherein the information for selecting the standalone non-public network may comprise one or more of: a user controlled prioritized list of preferred standalone non-public networks; a credentials holder controlled prioritized list of preferred standalone non-public networks; and a credentials holder controlled prioritized list of group identifiers for network selection.

Registering the user equipment with the first network may comprise sending, to the first network, information indicating that the user equipment supports dual registrations.

According to a forty-second aspect there is provided a method comprising: receiving information indicating that a user equipment supports dual registrations for registering with a first network and a standalone non-public network; based on the receiving, determining to provide the user equipment with information for selecting the standalone non-public network based on the user equipment's registration with the first network; and sending, to the user equipment, the information for selecting the standalone non-public network.

The information for selecting the standalone non-public network may comprise information indicating one or more prioritized sets of candidate standalone non-public networks, and wherein each prioritized set of candidate standalone non-public networks may comprise a plurality of candidate standalone non-public networks and may be associated with a respective combination of first network and access technology used by the user equipment to access the first network.

Each prioritized set may comprise: an identifier of a subscribed standalone non-public network; and a prioritized list of candidate standalone non-public networks for second standalone non-public network selection.

The user equipment may have a registration associated with a public land mobile network subscription, and wherein the information for selecting the standalone non-public network may comprise one or more of: a user controlled prioritized list of preferred standalone non-public networks; a credentials holder controlled prioritized list of preferred standalone non-public networks; and a credentials holder controlled prioritized list of group identifiers for network selection.

The information indicating that the user equipment supports dual registrations may be received during registering the user equipment with a standalone non-public network.

Determining to provide the user equipment with information for selecting the standalone non-public network may comprise: determining to provide the user equipment with information for selecting the standalone non-public network based on the information indicating that the user equipment supports dual registrations; or receiving, from a first application function, information for causing the apparatus to send, to the user equipment, the information for selecting the second network based on the user equipment's registration with the first network; and determining to provide the user equipment with the information for selecting the second network based on the information received from the first application function.

The first application function may be a steering of roaming application function.

The method may further comprise: sending, to an authentication server function, a protection request comprising the information for selecting the standalone non-public network; receiving, from the authentication server function, a protection response comprising a medium access control element; wherein sending the information for selecting the standalone non-public network may further comprise sending the medium access control element.

The method may be performed by an apparatus for a subscribed standalone non-public network or an apparatus for a credential holder network.

The credential holder network may be a further standalone non-public network or a home public land mobile network.

According to a forty-third aspect there is provided a method performed by a first application function, the method comprising: determining to cause sending, to a user equipment, information for selecting a standalone non-public network based on the user equipment's registration with a first network; and sending, to an apparatus, information for causing the apparatus to send, to the user equipment, the information for selecting the standalone non-public network based on the user equipment's registration with the first network.

The method may be performed by a steering of roaming application function.

According to a forty-fourth aspect there is provided a method comprising: receiving, from an apparatus, a protection request comprising information for a user equipment to perform selecting a standalone non-public network based on the user equipment's registration with a first network; determining, based on the request, a medium access control element associated with the information for the user equipment to perform selecting the standalone non-public network based on the user equipment's registration with the first network; and sending, to the apparatus, a protection response comprising the medium access control element.

According to a forty-fifth aspect there is provided a method performed by a subscribed standalone non-public network or credential holder network of the user equipment, the method comprising the methods of any of the forty-second to forty-fourth aspects.

According to a forty-sixth aspect, there is provided a computer readable medium comprising instructions which, when executed by a user equipment, cause the user equipment to perform at least the following: registering the user equipment with a first network; selecting a second network to register a user equipment with based on the user equipment's registration with the first network; and registering the user equipment with the selected second network.

The instructions, when executed, may cause the user equipment to further perform: receiving information for selecting the second network, wherein: the information for selecting the second network may comprise information indicating one or more prioritized sets of candidate second networks, each prioritized set of candidate second networks may comprise a plurality of candidate second networks and may be associated with a respective combination of first network and access technology used by the user equipment to access the first network, and the selecting may be further based on the information for selecting the second network.

Selecting the second network may comprise: selecting one of the one or more prioritized sets of candidate second networks associated with the combination of first network and access technology used for the user equipment's registration with the first network; and selecting the second network from among the plurality of candidate second networks comprised in the selected prioritized set.

Selecting the second network from among the plurality of candidate second networks may be based on a priority order of the candidate second networks in the selected prioritized set.

Registering the user equipment with the first network may comprise sending, to the first network, information indicating that the user equipment supports dual registrations.

According to a forty-seventh aspect, there is provided a computer readable medium comprising instructions which, when executed by an apparatus, cause the apparatus to perform at least the following: receiving information indicating that a user equipment supports dual registrations for registering with a first network and a second network; based on the receiving, determining to provide the user equipment with information for selecting the second network based on the user equipment's registration with the first network; and sending, to the user equipment, the information for selecting the second network.

The information for selecting the second network may comprise information indicating one or more prioritized sets of candidate second networks, wherein each prioritized set of candidate second networks may comprise a plurality of candidate second networks and may be associated with a respective combination of first network and access technology used by the user equipment to access the first network.

The information indicating that the user equipment supports dual registrations may be received during registering the user equipment with a home network or a visited network.

Determining to provide the user equipment with information for selecting the second network may comprise: determining to provide the user equipment with information for selecting the second network based on the information indicating that the user equipment supports dual registrations; or receiving, from a first application function, information for causing the apparatus to send, to the user equipment, the information for selecting the second network based on the user equipment's registration with the first network; and determining to provide the user equipment with the information for selecting the second network based on the information received from the first application function.

The first application function may be a steering of roaming application function.

The instructions, when executed, may cause the apparatus to further perform: sending, to an authentication server function, a protection request comprising the information for selecting the second network; receiving, from the authentication server function, a protection response comprising a medium access control element; wherein sending the information for selecting the second network may further comprise sending the medium access control element.

The apparatus may comprise an apparatus for a unified data management function or an apparatus for a second application function.

According to a forty-eighth aspect, there is provided a computer readable medium comprising instructions which, when executed by an apparatus for a first application function, cause the apparatus to perform at least the following: determining to cause sending, to a user equipment, information for selecting a second network based on the user equipment's registration with a first network; and sending, to an apparatus, information for causing the apparatus to send, to the user equipment, the information for selecting the second network based on the user equipment's registration with the first network.

The first application function may be a steering of roaming application function.

According to a forty-ninth, there is provided a computer readable medium comprising instructions which, when executed by an apparatus for an authentication server function, cause the apparatus to perform at least the following: receiving, from an apparatus, a protection request comprising information for a user equipment to perform selecting a second network based on the user equipment's registration with a first network; determining, based on the request, a medium access control element associated with the information for the user equipment to perform selecting the second network based on the user equipment's registration with the first network; and sending, to the apparatus, a protection response comprising the medium access control element.

According to a fiftieth aspect, there is provided a computer readable medium comprising instructions which, when executed by a user equipment, cause the user equipment to perform at least the following: registering the user equipment with a first public land mobile network; selecting a second public land mobile network to register a user equipment with based on the user equipment's registration with the first public land mobile network; and registering the user equipment with the selected second public land mobile network.

The instructions, when executed, may cause the user equipment to further perform: receiving information for selecting the second public land mobile network, wherein: the information for selecting the second public land mobile network may comprise information indicating one or more prioritized sets of candidate second public land mobile networks, each prioritized set of candidate second public land mobile networks may comprise a plurality of candidate second public land mobile networks and is associated with a respective combination of first public land mobile network and access technology used by the user equipment to access the first public land mobile network, and the selecting may be further based on the information for selecting the second public land mobile network.

Selecting the second public land mobile network may comprise: selecting one of the one or more prioritized sets of candidate second public land mobile networks associated with the combination of first public land mobile network and access technology used for the user equipment's registration with the first public land mobile network; and selecting the second public land mobile network from among the plurality of candidate second public land mobile networks comprised in the selected prioritized set.

Selecting the second public land mobile network from among the plurality of candidate second public land mobile networks may be based on a priority order of the candidate second public land mobile networks in the selected prioritized set.

The information for selecting the second public land mobile network may comprise one or more of: an operator controlled second public land mobile network selector with access technology list; a user controlled second public land mobile network selector with access technology list; a second home public land mobile network selector with access technology list; an operator controlled public land mobile network selector with access technology list; a user controlled public land mobile network selector with access technology list; or a home public land mobile network selector with access technology list.

Registering the user equipment with the first public land mobile network may comprise sending, to the first public land mobile network, information indicating that the user equipment supports dual registrations.

According to a fifty-first aspect, there is provided a computer readable medium comprising instructions which, when executed by an apparatus, cause the apparatus to perform at least the following: receiving information indicating that a user equipment supports dual registrations for registering with a first public land mobile network and a second public land mobile network; based on the receiving, determining to provide the user equipment with information for selecting the second public land mobile network based on the user equipment's registration with the first public land mobile network; and sending, to the user equipment, the information for selecting the second public land mobile network.

The information for selecting the second public land mobile network may comprise information indicating one or more prioritized sets of candidate second public land mobile networks, wherein each prioritized set of candidate second public land mobile networks may comprise a plurality of candidate second public land mobile networks and may be associated with a respective combination of first public land mobile network and access technology used by the user equipment to access the first public land mobile network.

The information for selecting the second public land mobile network may comprise one or more of: an operator controlled second public land mobile network selector with access technology list; a second home public land mobile network selector with access technology list; a user controlled second public land mobile network selector with access technology list; an operator controlled public land mobile network selector with access technology list; a user controlled public land mobile network selector with access technology list; or a home public land mobile network selector with access technology list.

The information indicating that the user equipment supports dual registrations may be received during registering the user equipment with a home public land mobile network or visited public land mobile network.

Determining to provide the user equipment with information for selecting the second public land mobile network may comprise: determining to provide the user equipment with information for selecting the second public land mobile network based on the information indicating that the user equipment supports dual registrations; or receiving, from a first application function, information for causing the apparatus to send, to the user equipment, the information for selecting the second public land mobile network based on the user equipment's registration with the first public land mobile network; and determining to provide the user equipment with the information for selecting the second public land mobile network based on the information received from the first application function.

The first application function may be a steering of roaming application function.

The instructions, when executed, may cause the apparatus to further perform: sending, to an authentication server function, a protection request comprising the information for selecting the second public land mobile network; receiving, from the authentication server function, a protection response comprising a medium access control element; wherein sending the information for selecting the second public land mobile network further may comprise sending the medium access control element.

The apparatus may comprise an apparatus for a unified data management function or an apparatus for a second application function.

According to a fifty-second aspect, there is provided a computer readable medium comprising instructions which, when executed by an apparatus for a first application function, cause the apparatus to perform at least the following: determining to cause sending, to a user equipment, information for selecting a second public land mobile network based on the user equipment's registration with a first public land mobile network; and sending, to an apparatus, information for causing the apparatus to send, to the user equipment, the information for selecting the second public land mobile network based on the user equipment's registration with the first public land mobile network.

The first application function may be a steering of roaming application function.

According to a fifty-third aspect, there is provided a computer readable medium comprising instructions which, when executed by an apparatus for an authentication server function, cause the apparatus to perform at least the following: receiving, from an apparatus, a protection request comprising information for a user equipment to perform selecting a second public land mobile network based on the user equipment's registration with a first public land mobile network; determining, based on the request, a medium access control element associated with the information for the user equipment to perform selecting the second public land mobile network based on the user equipment's registration with the first public land mobile network; and sending, to the apparatus, a protection response comprising the medium access control element.

According to a fifty-fourth, there is provided a computer readable medium comprising instructions which, when executed by a user equipment, cause the user equipment to perform at least the following: registering the user equipment with a first network; selecting a standalone non-public network to register a user equipment with based on the user equipment's registration with the first network; and registering the user equipment with the selected standalone non-public network.

The instructions, when executed, may cause the user equipment to further perform: receiving information for selecting the standalone non-public network, wherein: the information for selecting the standalone non-public network may comprise information indicating one or more prioritized sets of candidate standalone non-public networks, each prioritized set of candidate standalone non-public networks may comprise a plurality of candidate standalone non-public networks and may be associated with a respective combination of first network and access technology used by the user equipment to access the first network, and the selecting may be further based on the information for selecting the standalone non-public network.

Selecting the standalone non-public network may comprise: selecting one of the one or more prioritized sets of candidate standalone non-public networks associated with the combination of first network and access technology used for the user equipment's registration with the first network; and selecting the standalone non-public network from among the plurality of candidate standalone non-public networks comprised in the selected prioritized set.

Each prioritized set may comprise: an identifier of a subscribed standalone non-public network; and a prioritized list of candidate standalone non-public networks for second standalone non-public network selection.

The first network may be a public land mobile network, and wherein selecting the standalone non-public network from among the plurality of candidate standalone non-public networks comprised in the selected prioritized set may comprise: prioritizing the standalone non-public network corresponding to the identifier of the subscribed standalone non-public network; and when the standalone non-public network corresponding to the identifier of the subscribed standalone non-public network is unavailable, selecting the standalone non-public network based on the prioritized list of standalone non-public networks.

The first network may be a further standalone non-public network, and wherein selecting the standalone non-public network from among the plurality of candidate standalone non-public networks comprised in the selected prioritized set may comprise: selecting the standalone non-public network based on the prioritized list of standalone non-public networks.

The user equipment may have a registration associated with a public land mobile network subscription, and wherein the information for selecting the standalone non-public network may comprise one or more of: a user controlled prioritized list of preferred standalone non-public networks; a credentials holder controlled prioritized list of preferred standalone non-public networks; and a credentials holder controlled prioritized list of group identifiers for network selection.

Registering the user equipment with the first network may comprise sending, to the first network, information indicating that the user equipment supports dual registrations.

According to a fifty-fifth aspect, there is provided a computer readable medium comprising instructions which, when executed by an apparatus, cause the apparatus to perform at least the following: receiving information indicating that a user equipment supports dual registrations for registering with a first network and a standalone non-public network; based on the receiving, determining to provide the user equipment with information for selecting the standalone non-public network based on the user equipment's registration with the first network; and sending, to the user equipment, the information for selecting the standalone non-public network.

The information for selecting the standalone non-public network may comprise information indicating one or more prioritized sets of candidate standalone non-public networks, and wherein each prioritized set of candidate standalone non-public networks may comprise a plurality of candidate standalone non-public networks and may be associated with a respective combination of first network and access technology used by the user equipment to access the first network.

Each prioritized set may comprise: an identifier of a subscribed standalone non-public network; and a prioritized list of candidate standalone non-public networks for second standalone non-public network selection.

The user equipment may have a registration associated with a public land mobile network subscription, and wherein the information for selecting the standalone non-public network may comprise one or more of: a user controlled prioritized list of preferred standalone non-public networks; a credentials holder controlled prioritized list of preferred standalone non-public networks; and a credentials holder controlled prioritized list of group identifiers for network selection.

The information indicating that the user equipment supports dual registrations may be received during registering the user equipment with a standalone non-public network.

Determining to provide the user equipment with information for selecting the standalone non-public network may comprise: determining to provide the user equipment with information for selecting the standalone non-public network based on the information indicating that the user equipment supports dual registrations; or receiving, from a first application function, information for causing the apparatus to send, to the user equipment, the information for selecting the second network based on the user equipment's registration with the first network; and determining to provide the user equipment with the information for selecting the second network based on the information received from the first application function.

The first application function may be a steering of roaming application function.

The instructions, when executed, may cause the apparatus to further perform: sending, to an authentication server function, a protection request comprising the information for selecting the standalone non-public network; receiving, from the authentication server function, a protection response comprising a medium access control element; wherein sending the information for selecting the standalone non-public network may further comprise sending the medium access control element.

The apparatus may comprise an apparatus for a subscribed standalone non-public network or an apparatus for a credential holder network.

The credential holder network may be a further standalone non-public network or a home public land mobile network.

According to a fifty-sixth aspect there is provided a computer readable medium comprising instructions which, when executed by an apparatus for a first application function, cause the apparatus to perform at least the following: determining to cause sending, to a user equipment, information for selecting a standalone non-public network based on the user equipment's registration with a first network; and sending, to an apparatus, information for causing the apparatus to send, to the user equipment, the information for selecting the standalone non-public network based on the user equipment's registration with the first network.

The apparatus may be an apparatus for a steering of roaming application function.

According to a fifty-seventh aspect, there is provided a computer readable medium comprising instructions which, when executed by an apparatus for an authentication server function, cause the apparatus to perform at least the following: receiving, from an apparatus, a protection request comprising information for a user equipment to perform selecting a standalone non-public network based on the user equipment's registration with a first network; determining, based on the request, a medium access control element associated with the information for the user equipment to perform selecting the standalone non-public network based on the user equipment's registration with the first network; and sending, to the apparatus, a protection response comprising the medium access control element.

According to a fifty-eighth aspect, there is provided a non-transitory computer readable medium comprising program instructions that, when executed by an apparatus, cause the apparatus to perform at least the method according to any of the preceding aspects.

In the above (and as provided herein), many different example embodiments have been described. It should be appreciated that further example embodiments may be provided by the combination of any two or more of the example embodiments described above (and as further herein).

### BRIEF DESCRIPTION OF FIGURES

In the following, some example embodiments will now be described, by way of non-limiting and illustrative example only, with reference to the accompanying Figures in which:

FIG. 1 shows a representation of a network system according to some example embodiments;

FIG. 2 shows a representation of a control apparatus according to some example embodiments;

FIG. 3 shows a representation of an apparatus according to some example embodiments;

FIG. 4 shows methods according to some examples;

FIGS. 5 and 6 show example structures of information for selecting the second network;

FIG. 7 shows a signalling exchange according to some examples.

### DETAILED DESCRIPTION

In the following, certain example embodiments are explained with reference to mobile communication devices capable of communication via a wireless cellular system and mobile communication systems serving such mobile communication devices. However, it is to be expressly understood that the description of any example embodiments is provided by way of non-limiting and illustrative example only, and that it is by no way intended to be understood as limiting.

The terminology used herein is generally provided for the purpose of describing certain example embodiments only and is not intended to be limiting. In the following, all technical and scientific terms used herein may have the same meaning as commonly understood by one of ordinary skill in the art to which this subject disclosure pertains, unless otherwise defined.

References in the subject disclosure to “an example embodiment,” “some example embodiments,” “certain example embodiments,” “various example embodiments,” and the like indicate that the referenced embodiment(s) described may include particular feature(s), structure(s), or characteristic(s), but it is not necessary that every example embodiment described herein includes the particular feature(s), structure(s), or characteristic(s). Moreover, such phrases are not necessarily referring to the same example embodiment. Further, when particular feature(s), structure(s), or characteristic(s) are described in connection with an example embodiment, it is submitted that it is within the knowledge of one skilled in the art to combine such feature(s), structure(s), or characteristic(s) in connection with any other example embodiments described herein, whether or not such combination is explicitly described.

As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used herein, unless stated explicitly, performing a step “in response to A” does not indicate that the step is performed immediately after “A” occurs, and one or more intervening steps may be included between “A” and the step.

As used herein, the expressions “first X” and “second X” include the options that “first X” is the same as “second X” and that “first X” is different from “second X”, unless otherwise specified. Thus, it shall be understood that although the terms “first,” “second,” and the like may be used herein to describe various elements, these elements should not be limited by these terms.

These terms are only used to distinguish one element from another. For example, a “first element” could be termed a “second element”, and similarly, a “second element” could be termed a “first element” without departing from the scope of the subject disclosure.

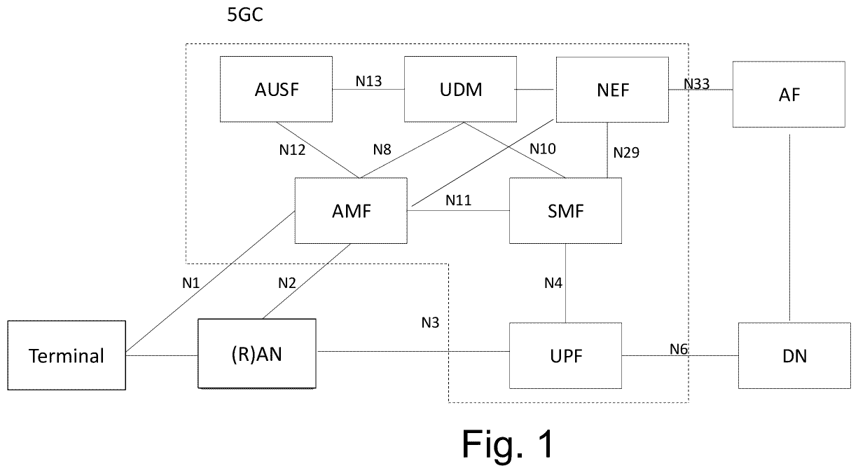

Before explaining in detail the various example embodiments, certain facets of a wireless communication system, access systems thereof, and mobile communication devices are briefly explained with reference to FIGS. 1, 2 and 3 to assist in understanding the technology underlying the described example embodiments.

FIG. 1 shows a schematic representation of a 5G system (5 GS). The 5GS may be comprised by a terminal or user equipment (UE), a 5G radio access network (5 GRAN) or next generation radio access network (NG-RAN), a 5G core network (5 GC), one or more application function (AF) and one or more data networks (DN).

The 5G-RAN may comprise one or more gNodeB (GNB) or one or more gNodeB (GNB) distributed unit functions connected to one or more gNodeB (GNB) centralized unit functions.

The 5GC may comprise the following entities: Network Slice Selection Function (NSSF); Network Exposure Function; Network Repository Function (NRF); Policy Control Function (PCF); Unified Data Management (UDM); Application Function (AF); Authentication Server Function (AUSF); an Access and Mobility Management Function (AMF); and Session Management Function (SMF). FIG. 1 also shows the various interfaces (N1, N2 etc.) that may be implemented between the various elements of the system.

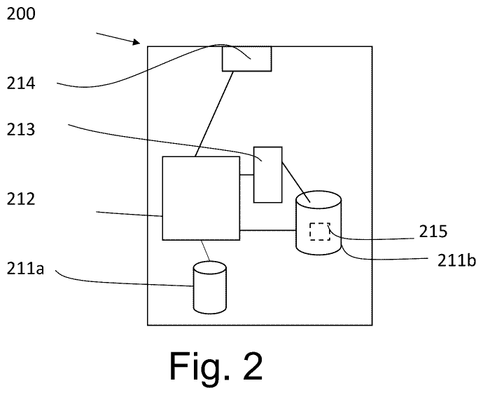

FIG. 2 illustrates an example of a control apparatus 200 for controlling a function of the 5GRAN or the 5GC as illustrated on FIG. 1. The control apparatus may comprise at least one random access memory (RAM) 211a, at least on read only memory (ROM) 211b, at least one processor 212, 213 and an input/output interface 214. The at least one processor 212, 213 may be coupled to the RAM 211a and the ROM 211b. The at least one processor 212, 213 may be configured to execute an appropriate software code 215. The software code 215 may for example allow to perform one or more steps to perform one or more of the present aspects. The software code 215 may be stored in the ROM 211b. The control apparatus 200 may be interconnected with another control apparatus 200 controlling another function of the 5GRAN or the 5GC. In some example embodiments, each function of the 5GRAN or the 5GC comprises a control apparatus 200. In alternative example embodiments, two or more functions of the 5GRAN or the 5GC may share a control apparatus.

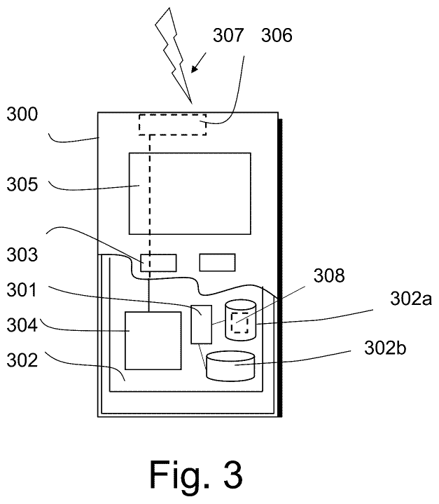

FIG. 3 illustrates an example of a terminal 300, such as the terminal illustrated on FIG. 1. The terminal 300 may be provided by any device configured to send and receive radio signals. Non-limiting and illustrative examples comprise a user equipment, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, an Internet of things (loT) type communication device or any combinations of these or the like. The terminal 300 may provide, for example, communication of datafor carrying communications. The communications may be one or more of voice, electronic mail (email), text message, multimedia, data, machine data and so on.

The terminal 300 may receive signals over an air or radio interface 307 via appropriate apparatus for receiving and may transmit signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the mobile device.

The terminal 300 may be provided with at least one processor 301, at least one memory ROM 302a, at least one RAM 302b and other possible components 303 for use in software and hardware aided execution of tasks it is designed to perform, including control of access to and communications with access systems and other communication devices. The at least one processor 301 is coupled to the RAM 302b and the ROM 302a. The at least one processor 301 may be configured to execute an appropriate software code 308. The software code 308 may for example allow to perform one or more of the present aspects. The software code 308 may be stored in the ROM 302a.

The processor, storage and other relevant control apparatus can be provided on an appropriate circuit board and/or in chipsets. This feature is denoted by reference 304. The device may optionally have a user interface such as key pad 305, touch sensitive screen or pad, combinations thereof or the like. Optionally one or more of a display, a speaker and a microphone may be provided depending on the type of the device.

In some example embodiments, a UE may have dual connectivity capability—for example the UE may be able to simultaneously maintain registrations with a first network and a second network. The two networks may be managed by the same operator or by different operators. The networks may for example be public land mobile networks (PLMNs), non-public networks (NPNs), or standalone NPNs (SNPNs).

Mechanisms defining how the UE selects the first network are already in place—for example using lists specified in existing standards, such as “HPLMN Selector with Access Technology” for registering to a home PLMN (HPLMN), or “Operator Controlled PLMN Selector with Access Technology” and “User Controlled PLMN Selector with Access Technology” to select a PLMN when the HPLMN is not available.

However, there exists a need to provide mechanisms to define how the UE selects the second network when the UE already has a registration with a first network. In particular, a mechanism is needed for the UE to select a second PLMN or SNPN for the second registration.

Some example embodiments may address this issue. Some example embodiments may provide mechanisms for the UE to select a second network to register with when the UE has an existing registration at a first network.

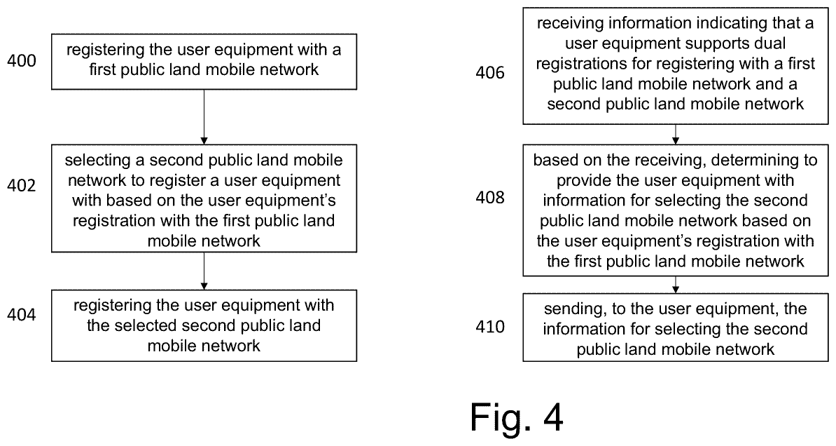

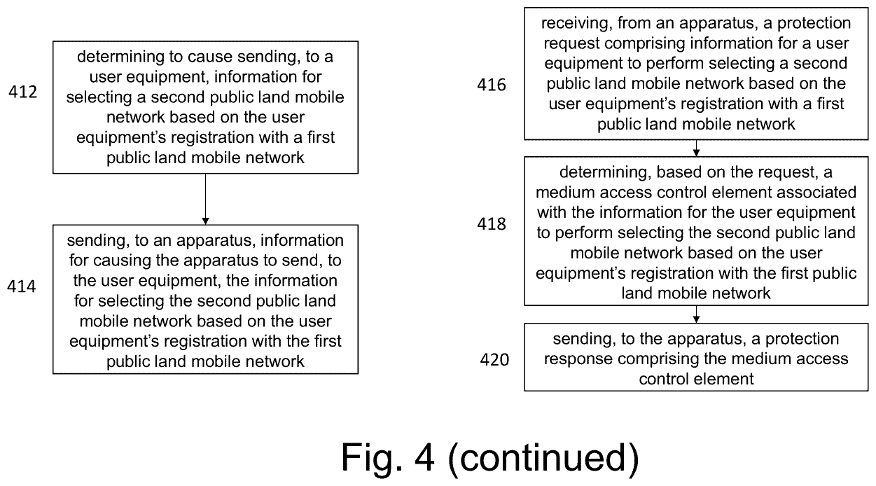

Reference is made to FIG. 4, which shows methods according to some example embodiments.

At 400, a method comprises registering the user equipment with a first public land mobile network.

At 402 the method comprises selecting a second public land mobile network to register a user equipment with based on the user equipment's registration with the first public land mobile network.

At 404, the method comprises registering the user equipment with the selected second public land mobile network.

In some example embodiments, steps 400-404 may be performed at or by a user equipment.

At 406, a method comprises receiving information indicating that a user equipment supports dual registrations for registering with a first public land mobile network and a second public land mobile network.

At 408, the method comprises, based on the receiving, determining to provide the user equipment with information for selecting the second public land mobile network based on the user equipment's registration with the first public land mobile network.

At 410, the method comprises sending, to the user equipment, the information for selecting the second public land mobile network.

In some example embodiments, steps 406-410 may be performed at or by an apparatus, such as an apparatus for a UDM or an apparatus for an application function.

At 412, a method comprises determining to cause sending, to a user equipment, information for selecting a second public land mobile network based on the user equipment's registration with a first public land mobile network.

At 414, the method comprises sending, to an apparatus, information for causing the apparatus to send, to the user equipment, the information for selecting the second public land mobile network based on the user equipment's registration with the first public land mobile network.

In some example embodiments, steps 412-414 may be performed at or by an apparatus for a first application function. In some example embodiments, the first application function may be a steering of roaming application function.

At 416, a method comprises receiving, from an apparatus, a protection request comprising information for a user equipment to perform selecting a second public land mobile network based on the user equipment's registration with a first public land mobile network.

At 418, the method comprises determining, based on the request, a medium access control element associated with the information for the user equipment to perform selecting the second public land mobile network based on the user equipment's registration with the first public land mobile network.

At 420, the method comprises sending, to the apparatus, a protection response comprising the medium access control element.

In some example embodiments, steps 416-420 may be performed at or by an apparatus for an authentication server function.

In some example embodiments, the UE may be configured with information for selecting the second network to register with. The UE may select the second network to register with based on this information.

For example, the UE may be configured with information for selecting the second network by the home network (e.g. a home network in India). The UE may subsequently register with a first network (e.g. the UE may travel from India to the USA and register with a first network while in the USA). The UE may then select a second network based on the UE's registration with the first network and the information for selecting the second network.

In some example embodiments, the information for selecting the second network may be provided in a new list, such as “second HPLMN Selector with Access Technology”, “Operator Controlled second PLMN Selector with Access Technology” and/or “User Controlled second PLMN Selector with Access Technology”, or may be modified versions of existing lists, such as “HPLMN Selector with Access Technology”, “Operator Controlled PLMN Selector with Access Technology” and “User Controlled PLMN Selector with Access Technology”, modified to include the information for selecting the second network to register with.

In some example embodiments, the UE may be configured with a “list of subscriber data”, which may include (per subscriber SUPI) additional information for selecting the second network to register with (e.g. a “prioritized list of SNPNs for second SNPN selection”).

In some example embodiments, the information for selecting the second network may be provided in a new list, such as “second user controlled prioritized list of preferred SNPNs”, “second credentials holder controlled prioritized list of preferred SNPNs” and/or “second credentials holder controlled prioritized list of GINs” (Group Identifiers for Network Selection), or modified versions of existing lists, such as “user controlled prioritized list of preferred SNPNs”, “credentials holder controlled prioritized list of preferred SNPNs” and/or “credentials holder controlled prioritized list of GINs”, modified to include the information for selecting the second network to register with.

In some example embodiments, the UE may receive the information for selecting the second network from a “home” network (e.g. a home PLMN (HPLMN)). For example, the UE may receive one or more of: the “second HPLMN Selector with Access Technology”, “Operator Controlled second PLMN Selector with Access Technology”, “User Controlled second PLMN Selector with Access Technology”, “second user controlled prioritized list of preferred SNPNs”, “second credentials holder controlled prioritized list of preferred SNPNs” and/or “second credentials holder controlled prioritized list of GINs” from the home network.

In some example embodiments, the UE may provide an indication of whether it supports multiple access registration. This may, in some example embodiments, be an explicit indication or by the way of including additional information (e.g. a “registration Id”) in the registration request when registering with the home network. The indication may be sent by the UE to the first network and/or home network when the UE register with the first network and/or home network.

Based on the indication, the UDM or other AF of the home network may store in a flag in the UEs subscription data indicating whether the UE supports multiple 3GPP access registration.

An application function at the home network, such as a steering of roaming (SoR) application function (AF), may determine whether the UE supports multiple access registration by checking the information associated with the UE stored in the UDM or other AF. In some example embodiments, the UE may be configured with the information for selecting the second network to register with in response to determining that the UE supports multiple access registration.

In some example embodiments, the information for selecting the second network may comprise one or more prioritized sets of candidate second networks. Each prioritized set may comprise one or more candidate second networks and a priority associated with each candidate second network. Each prioritized set of candidate second networks may be associated with the user equipment's registration to a first network and an access technology or access type used to access the first network. In some example embodiments, the first network may be the home network, or in other example embodiments may be a different network (for example, the home network may be a HPLMN and the first network may be a visited PLMN (VPLMN)). The home network may be a PLMN, NPN or SNPN.

In some example embodiments, the UE may select the candidate second network based on the UE's registration with the first network. For example, the UE may select the prioritized set of candidate second networks associated with the first network with which the UE is registered with. The UE may then select the second network from the selected prioritized set of candidate second networks. The UE may select the second network in order of priority indicated in the prioritized set.

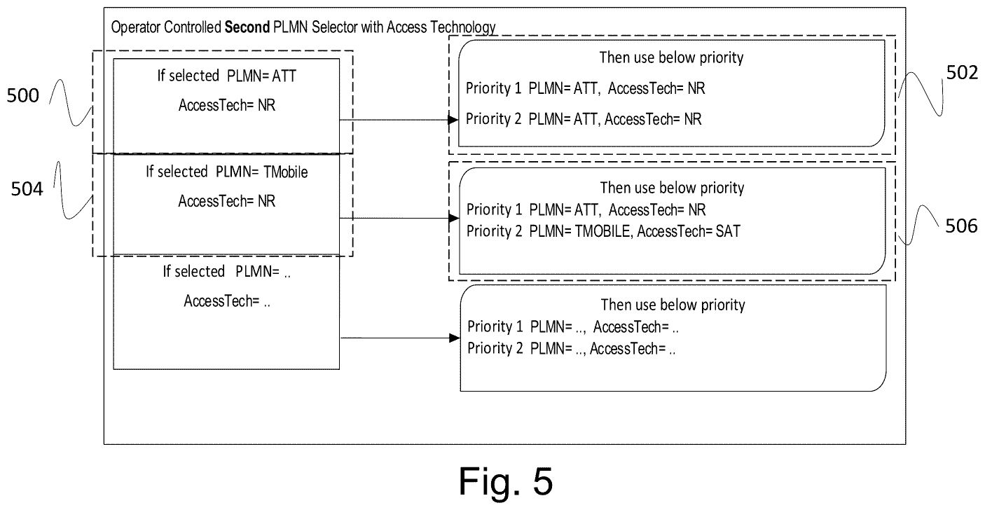

FIG. 5 shows an example structure of the information for selecting the second network. In particular, in the example of FIG. 5, the first and second networks are PLMNs. The example shown in FIG. 5 may represent a new list, such as the “Operator Controlled second PLMN Selector with Access Technology” mentioned previously.

As illustrated in FIG. 5, if the user equipment's registration to the first network is a first combination 500, the user equipment may select a first prioritized set of candidate second networks 502. If the user equipment's registration to the first network is a second combination 504, then the user equipment may select a second prioritized set of candidate second networks 506.

In the example shown in FIG. 5, the first combination is “ATT” (indicating AT&T as the PLMN provider) and the access technology/type is “NR”, and the first prioritized set of candidate second networks comprises “PLMN=ATT, Access Technology=NR” with priority 1, and “PLMN=ATT, Access Technology=NR” with priority 2.

That is to say, if the UE's registration with the first network is with AT&T using NR access, then the UE may select a second network that is provided by AT&T using NR access.

As further illustrated in FIG. 5, the second combination is “T-Mobile US” and the access technology/type is “NR”, and the second prioritized set of candidate second networks comprises “PLMN=ATT, Access Technology=NR” with priority 1, and “PLMN=TMOBILE, Access Technology=SAT” with priority 2.

That is to say, if the UE's registration with the first network is with T-Mobile US using NR access, then the UE may prioritize selecting a second network that is provided by AT&T using NR access and if that is not available the UE may fall back to selecting a second network provided by T-Mobile using satellite access.

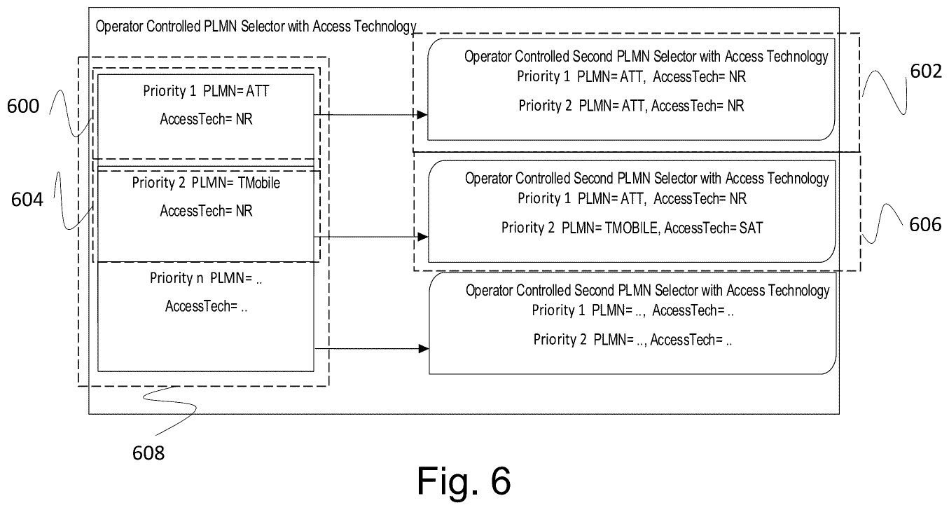

FIG. 6 illustrates another example structure of the information for selecting the second network. In the example of FIG. 6, the first and second networks are PLMNs. The example shown in FIG. 6 may represent a modified version of the existing lists, such as “Operator Controlled PLMN Selector with Access Technology” mentioned previously.

As shown in FIG. 6, information may comprise a plurality of combinations 608 of candidate first networks and access technologies/types for accessing the associated first network. For each candidate first network, there is an associated prioritized set of candidate second networks provided in a nested fashion.

For example, as shown in FIG. 6, there are two candidate first network combinations—a first candidate 600 (“PLMN=ATT, Access Technology=NR”) with a higher priority than the second candidate 604 (“PLMN=TMobile, Access Technology=NR”). Depending on which candidate first network combination is selected for the user equipment's registration to the first network, the user equipment may have different prioritized sets of candidate second networks.

As shown in FIG. 6, if the user equipment selects the first candidate first network combination 600 (“PLMN=ATT, Access Technology=NR”), then the user equipment is presented with a first prioritized set of candidate second networks 602 (“PLMN=ATT, Access Technology=NR” with priority 1 and “PLMN=ATT, Access Technology=NR” with priority 2).

However if the user equipment is unable to access the first candidate first network using the first candidate first network combination 600, the user equipment may select the second candidate first network combination 604 (“PLMN=TMobile, Access Technology=NR”), and then the user equipment is presented with a second prioritized set of candidate second networks 606 (“PLMN=ATT, Access Technology=NR” with priority 1 and “PLMN=TMobile, Access Technology=SAT” with priority 2).

It should be understood that while the example embodiments shown in FIGS. 5 and 6 relate to an “Operator Controlled PLMN Selector with Access Technology”, the principles described above may be applied to other lists, such as but not limited to “HPLMN Selector with Access Technology” and “User Controlled PLMN Selector with Access Technology”. It should be further understood that the concepts described above in relation to PLMN selection may be adapted to SNPN selection, as will be described in further detail below.

Furthermore, it should be understood that in some example embodiments, different network providers and access technologies/types other than those shown in FIGS. 5 and 6 may be used. It should be understood that, in some example embodiments, for a first combination of first network and access type, there may be a first prioritized set of candidate second networks, and for a second combination of first network and access type, there may be a second prioritized set of candidate second networks. The candidate second networks in the first and second prioritized sets may be different or may be the same. There may be a further priority order of different combinations of first network and access type for the user equipment to use when selecting the first network to register with.

In some example embodiments, the home network (e.g., UDM/AF/SoR AF) may provide the information for selecting the second network data to the UE. The UE may then select the second network based on the received information.

In some example embodiments, for performing SNPN selection the UE may be configured with a list, such as a “list of subscriber data”. Each entry in the list may comprise a subscriber identity (e.g. in the form of SUPI) and an SNPN ID sorresponding to the subscribed SNPN, and optionally additional information.

In some example embodiments, if the UE has a USIM with a first network (e.g. PLMN) subscription, the UE may be configured with SNPN selection parameters associated with the first network subscription. For example, the UE may configured with information indicating one or more of: a user controlled prioritized set of preferred SNPNs, a credentials holder controlled prioritized set of preferred SNPNs, and/or a credentials holder controlled prioritized set of GINs.

In some example embodiments, the UE may be configured with a list, such as a modified version of the “list of subscriber data”, comprising the information for selecting the second network. In some example embodiments, the information for selecting the second network may comprise a “prioritized set of SNPNs for second SNPN selection”.

In some example embodiments, each entry in the list may comprise a SUPI, a Subscribed SNPN ID, and a prioritized set of SNPN IDs for second SNPN selection.

In some example embodiments, when the UE is performing network selection for the first registration (e.g. registering with the first network), the UE may give highest priority to an SNPN corresponding to the subscribed SNPN ID. If the SNPN corresponding to the subscribed SNPN ID is not available, the UE may search for available SNPNs (in the order of priority) based on the prioritized set of SNPN IDs for second SNPN selection that is associated with the subscription (SUPI) for the first registration.

In some example embodiments, when the UE is performing network selection for the second network registration, if the UE is already registered to the SNPN corresponding to the subscribed SNPN ID (due to the first registration), then the UE may search for available SNPNs (in the order of priority) from the prioritized set of SNPN IDs for second SNPN selection that is associated with the subscription (SUPI). If the UE is registered to a PLMN (due to the first registration), the UE may give highest priority to the SNPN corresponding to the subscribed SNPN ID for the second network registration. If the SNPN corresponding to the subscribed SNPN ID is not available, the UE may search for available SNPNs (in the order of priority) from the prioritized set of SNPN IDs for second SNPN selection for the second network registration.

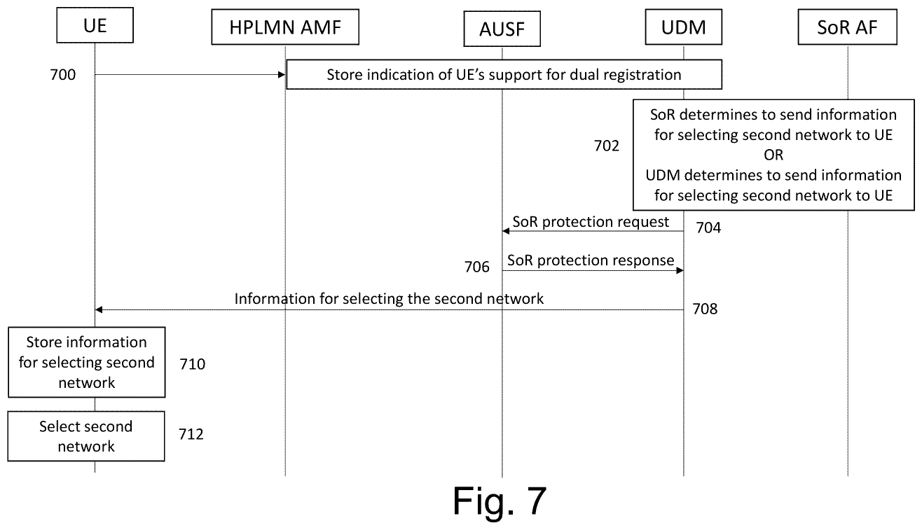

Reference is made to FIG. 7, which shows an example signalling exchange for performing network selection. In particular, FIG. 7 shows an example where the UE is configured with the information for selecting the second network by the home network (which in the example of FIG. 7 is a PLMN), and that the UE is selecting a second PLMN to register with. In the example shown in FIG. 7 and described below, reference is made to a UDM—it should be understood that, in some example embodiments, the UDM may be replaced by another AF that performs the same functions as the UDM. It should be understood that the example signalling exchange shown in FIG. 7 may be adapted for SNPN selections, as described previously. In the case of SNPN selection, the home network may be a subscribed SNPN (e.g. an SNPN to which the UE is subscribed) or may be a credential holder network (e.g. an SNPN or PLMN).

At 700, during registration with the home network, the UE may provide an indication that it supports dual registration. The indication may be sent from the UE to the home network in a registration message. Alternatively, the UE may provide a registration identifier as part of the registration. The UDM of the home may store the indication that the UE supports dual registration.

At 702, an AF (e.g. SoR AF) of the home network may determine to send information for selecting the second network to the UE. For example, the AF may check if the UE supports multiple access registration by checking the flag in the UDM. When the AF determines that the UE supports multiple access registration, the AF may provide the information for selecting the second network to the UDM.

Alternatively, the UDM may determine to send the information for selecting the second network to the UE. For example, the UDM may determine whether the UE supports multiple access registration by checking the flag, and based on the flag the UDM may determine the information for selecting the second network is to be delivered to UE.

The information for selecting the second network may be as described previously.

At 704, the UDM may determine to use a secured packet mechanism (e.g., as defined in 3GPP TS 31.115) and sends a protection request (e.g. an SoR protection request) to the AUSF. The protection request may comprise the information for selecting the second network.

At 706, the AUSF may generate a MAC-IAUSF (e.g. an SOR-MAC-IAUSF) comprising the information for selecting the second network and send a response comprising the generated MAC-IAUSF to the UDM. The AUSF may also send counter information associated with the MAC-IAUSF.

At 708, the UDM may send the information for selecting the second network to the UE via one or more intermediate nodes, such as an AMF. In some example embodiments, the UDM may send the MAC-IAUSF received from the AUSF to the UE. The UE may generate its own version of MAC-IAUSF based on the received information for selecting the second network and compare the MAC-IAUSF generated by the UE to the MAC-IAUSF received from the UDM. When the two MAC-IAUSF are the same, the UE may determine that the information for selecting the second network has not been modified by the intermediate nodes.

At 710, the UE may store the information for selecting the second network. For example, the Universal Integrated Circuit Card (UICC) may store the information.

In some example embodiments, if the home network has requested for re-registration (e.g., due to new configuration update), the UE may trigger a registration request with the updated information.

At 712 the UE may select a secondary PLMN based on the provided information for selecting the second network and the user equipment's registration with the first network. The information for selecting the second network may be as described previously.

Various example embodiments have been described in which a UE may select a second network for secondary registration based on the UE's registration with a first network. The home network may configure the UE with the information for selecting the second network.

For example, the UE may be configured with a plurality of prioritized sets of candidate second networks, each set being associated with a different combination of first network and access technology used to access the first network. The UE may select a prioritized set associated with the combination of first network and access technology used for the UE's registration with that network, and then select the second network according to the selected prioritized set.

In some example embodiments, there is provided a user equipment comprising means for: registering the user equipment with a first public land mobile network; selecting a second public land mobile network to register a user equipment with based on the user equipment's registration with the first public land mobile network; and registering the user equipment with the selected second public land mobile network.

In some example embodiments, there is provided a user equipment comprising at least one processor and at least one memory storing instructions that, when executed by the at least one processor, cause the user equipment at least to: register the user equipment with a first public land mobile network; select a second public land mobile network to register a user equipment with based on the user equipment's registration with the first public land mobile network; and register the user equipment with the selected second public land mobile network.

In some example embodiments, there is provided an apparatus comprising means for receiving information indicating that a user equipment supports dual registrations for registering with a first public land mobile network and a second public land mobile network; based on the receiving, determining to provide the user equipment with information for selecting the second public land mobile network based on the user equipment's registration with the first public land mobile network; and sending, to the user equipment, the information for selecting the second public land mobile network.

In some example embodiments, there is provided an apparatus comprising at least one processor and at least one memory storing instructions that, when executed by the at least one processor, cause the apparatus at least to: receive information indicating that a user equipment supports dual registrations for registering with a first public land mobile network and a second public land mobile network; based on the receiving, determine to provide the user equipment with information for selecting the second public land mobile network based on the user equipment's registration with the first public land mobile network; and send, to the user equipment, the information for selecting the second public land mobile network.

In some example embodiments, the apparatus may be implemented as an apparatus for a UDM. The apparatus may, for example, be configured to operate as a UDM. In particular, the apparatus may be configured to perform one or more functions of a UDM.

Additionally or alternatively, the apparatus may be implemented as an apparatus for an application function in some example embodiments. The apparatus may, for example, be configured to operate as an application function. In particular, the apparatus may be configured to perform one or more functions of an application function.

In some example embodiments, there is provided an apparatus for a first application function, the apparatus comprising means for: determining to cause sending, to a user equipment, information for selecting a second public land mobile network based on the user equipment's registration with a first public land mobile network; and sending, to an apparatus, information for causing the apparatus to send, to the user equipment, the information for selecting the second public land mobile network based on the user equipment's registration with the first public land mobile network.

In some example embodiments, there is provided an apparatus for a first application function, the apparatus comprising at least one processor and at least one memory storing instructions that, when executed by the at least one processor, cause the apparatus at least to: determine to cause sending, to a user equipment, information for selecting a second public land mobile network based on the user equipment's registration with a first public land mobile network; and send, to an apparatus, information for causing the apparatus to send, to the user equipment, the information for selecting the second public land mobile network based on the user equipment's registration with the first public land mobile network.

In some example embodiments, there is provided an apparatus for an authentication server function, the apparatus comprising means for: receiving, from an apparatus, a protection request comprising information for a user equipment to perform selecting a second public land mobile network based on the user equipment's registration with a first public land mobile network; determining, based on the request, a medium access control element associated with the information for the user equipment to perform selecting the second public land mobile network based on the user equipment's registration with the first public land mobile network; and sending, to the apparatus, a protection response comprising the medium access control element.

In some example embodiments, there is provided an apparatus for an authentication server function, the apparatus comprising at least one processor and at least one memory storing instructions that, when executed by the at least one processor, cause the apparatus at least to: receive, from an apparatus, a protection request comprising information for a user equipment to perform selecting a second public land mobile network based on the user equipment's registration with a first public land mobile network; determine, based on the request, a medium access control element associated with the information for the user equipment to perform selecting the second public land mobile network based on the user equipment's registration with the first public land mobile network; and send, to the apparatus, a protection response comprising the medium access control element.

It is understood that references in the above to various network functions (e.g., to an AMF, an SMF, etc.) may comprise apparatus that perform at least some of the functionality associated with those network functions. Further, an apparatus comprising a network function may comprise a virtual network function instance of that network function.

It should be understood that the apparatus may comprise or be coupled to other units or modules etc., such as radio parts or radio heads, used in or for transmission and/or reception.

Although the apparatus have been described as one entity, different modules and memory may be implemented in one or more physical or logical entities.

It is noted that whilst some example embodiments have been described in relation to 5G networks, similar concepts can be applied in relation to other networks and communication systems (such as 4G, 6G, 7G, etc., and/or in other wireless or wired communication networks).

Therefore, although certain example embodiments were described above by way of non-limiting and illustrative example with reference to certain example architectures for wireless networks, technologies and standards, example embodiments may be applied to any other suitable forms of communication systems than those illustrated and described herein.

It is also noted herein that while the above describes various example embodiments, there are several variations and modifications which may be made to the without departing from the scope of the subject disclosure.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. As used herein, the expression “and/or” includes any and all combinations of one or more of the listed terms.

In general, the various example embodiments may be implemented in hardware or special purpose circuitry, software, logic or any combination thereof. Some example embodiments of the subject disclosure may be implemented in hardware, while other aspects may be implemented in firmware or software which may be executed by a controller, microprocessor or other computing device, although the disclosure is not limited thereto. While various example embodiments of the subject disclosure may be illustrated and described as block diagrams, flow charts, or using some other pictorial representation, it is well understood that these blocks, apparatus, systems, techniques or methods described herein may be implemented in, as non-limiting and illustrative examples, hardware, software, firmware, special purpose circuits or logic, general purpose hardware or controller or other computing devices, or some combination thereof.

As used herein, the term “circuitry” may refer to one or more or all of the following example embodiments:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term herein, including in any claims. As a further example, as used herein, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The various example embodiments of this subject disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out any of the example embodiments (or some combination thereof). The one or more computer-executable components may be at least one software code or portions of it.

Further, in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The term “non-transitory,” as used herein, is a limitation of the medium itself (e.g., tangible, not a signal) as opposed to a limitation on data storage persistency (e.g., RAM vs. ROM).

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting and illustrative examples.

Example embodiments of the subject disclosure may be practiced in various components, such as integrated circuit modules. The design of integrated circuits is by and large a highly automated process. Complex and powerful software tools are available for converting a logic level design into a semiconductor circuit design ready to be etched and formed on a semiconductor substrate.

The scope of protection sought for various example embodiments of the subject disclosure is set out by the independent claims. The example embodiments and aspects, features, etc. thereof, if any, described herein that do not fall under the scope of the independent claims are to be interpreted as examples useful for understanding various example embodiments of the subject disclosure.

The subject disclosure has provided, by way of non-limiting and illustrative examples, a full and informative description of the various example embodiments herein. However, various modifications and adaptations may become apparent to those skilled in the relevant arts in view of the foregoing description, when read in conjunction with the accompanying drawings and the claims. However, all such and similar modifications of the teachings of the various example embodiments will still fall within the scope of the subject disclosure. Indeed, there is a further example embodiment comprising a combination of one or more example embodiments with any of the other example embodiments described herein.

1. A user equipment comprising at least one processor and at least one memory storing instructions that, when executed by the at least one processor, cause the user equipment at least to perform:
registering the user equipment with a first public land mobile network;
selecting a second public land mobile network to register a user equipment with based on the user equipment's registration with the first public land mobile network; and
registering the user equipment with the selected second public land mobile network.

2. The user equipment of claim 1, wherein the instructions, when executed by the at least one processor, further cause the user equipment to perform:
receiving information for selecting the second public land mobile network, wherein:
the information for selecting the second public land mobile network comprises information indicating one or more prioritized sets of candidate second public land mobile networks,
each prioritized set of candidate second public land mobile networks comprises a plurality of candidate second public land mobile networks and is associated with a respective combination of first public land mobile network and access technology used by the user equipment to access the first public land mobile network, and
the selecting is further based on the information for selecting the second public land mobile network.

3. The user equipment of claim 2, wherein selecting the second public land mobile network comprises:
selecting one of the one or more prioritized sets of candidate second public land mobile networks associated with the combination of first public land mobile network and access technology used for the user equipment's registration with the first public land mobile network; and
selecting the second public land mobile network from among the plurality of candidate second public land mobile networks comprised in the selected prioritized set.

4. The user equipment of claim 3, wherein selecting the second public land mobile network from among the plurality of candidate second public land mobile networks is based on a priority order of the candidate second public land mobile networks in the selected prioritized set.

5. The user equipment of claim 2, wherein the information for selecting the second public land mobile network comprises one or more of:
an operator controlled second public land mobile network selector with access technology list;
a user controlled second public land mobile network selector with access technology list;
a second home public land mobile network selector with access technology list;
an operator controlled public land mobile network selector with access technology list;
a user controlled public land mobile network selector with access technology list; or
a home public land mobile network selector with access technology list.

6. The user equipment of claim 1, wherein registering the user equipment with the first public land mobile network comprises sending, to the first public land mobile network, information indicating that the user equipment supports dual registrations.

7. An apparatus comprising at least one processor and at least one memory storing instructions that, when executed by the at least one processor, cause the user equipment at least to perform:
receiving information indicating that a user equipment supports dual registrations for registering with a first public land mobile network and a second public land mobile network;
based on the receiving, determining to provide the user equipment with information for selecting the second public land mobile network based on the user equipment's registration with the first public land mobile network; and
sending, to the user equipment, the information for selecting the second public land mobile network.

8. The apparatus of claim 7, wherein the information for selecting the second public land mobile network comprises information indicating one or more prioritized sets of candidate second public land mobile networks, wherein each prioritized set of candidate second public land mobile networks comprises a plurality of candidate second public land mobile networks and is associated with a respective combination of first public land mobile network and access technology used by the user equipment to access the first public land mobile network.

9. The apparatus of claim 7, wherein the information for selecting the second public land mobile network comprises one or more of:
an operator controlled second public land mobile network selector with access technology list;
a second home public land mobile network selector with access technology list;
a user controlled second public land mobile network selector with access technology list;
an operator controlled public land mobile network selector with access technology list;
a user controlled public land mobile network selector with access technology list; or
a home public land mobile network selector with access technology list.

10. The apparatus of claim 7, wherein the information indicating that the user equipment supports dual registrations is received during registering the user equipment with a home public land mobile network or visited public land mobile network.

11. The apparatus of claim 10, wherein determining to provide the user equipment with information for selecting the second public land mobile network comprises:
determining to provide the user equipment with information for selecting the second public land mobile network based on the information indicating that the user equipment supports dual registrations; or
receiving, from a first application function, information for causing the apparatus to send, to the user equipment, the information for selecting the second public land mobile network based on the user equipment's registration with the first public land mobile network;
and determining to provide the user equipment with the information for selecting the second public land mobile network based on the information received from the first application function.

12. The apparatus of claim 11, wherein the first application function is a steering of roaming application function.

13. The apparatus of claim 7, wherein the instructions, when executed by the at least one processor, further cause the user equipment to perform:
sending, to an authentication server function, a protection request comprising the information for selecting the second public land mobile network; and
receiving, from the authentication server function, a protection response comprising a medium access control element;
wherein sending the information for selecting the second public land mobile network further comprises sending the medium access control element.

14. The apparatus of claim 7, wherein the apparatus is an apparatus for a unified data management function or an apparatus for a second application function.

15. An apparatus for a first application function, the apparatus comprising at least one processor and at least one memory storing instructions that, when executed by the at least one processor, cause the user equipment at least to perform:
determining to cause sending, to a user equipment, information for selecting a second public land mobile network based on the user equipment's registration with a first public land mobile network; and
sending, to another apparatus, information for causing the another apparatus to send, to the user equipment, the information for selecting the second public land mobile network based on the user equipment's registration with the first public land mobile network.

16. The apparatus of claim 15, wherein the first application function is a steering of roaming application function.
